(19) United States
(12) Patent Application Publication
(10) Pub. No.: US 2018/0361832 A1
(43) Pub. Date: Dec. 20, 2018

(54) MOTOR-VEHICLE DOOR

(71) Applicant: BOS GMBH & CO. KG, Ostfildern (DE)

(72) Inventors: Gerald ZIMMERMANN, Ottenbach (DE); Markus HINTENNACH, Baltmannsweiler (DE)

(21) Appl. No.: 15/736,823

(22) PCT Filed: May 20, 2016
(86) PCT No.: PCT/EP2016/061410

§ 371 Date: Dec. 15, 2017

(30) Foreign Application Priority Data
Jun. 17, 2015 (DE) 10 2015 007 651.5

(51) Int. Cl. B60J 1/20

(52) U.S. Cl. CPC B60J 1/2063; B60J 1/2072; B60J 1/2086

(57) ABSTRACT

A motor-vehicle door, including a pane assembly, which is integrated in a door body structure, and a shading device, which is associated with the pane assembly on the inside of the door and which has a plurality of functional components, and a door interior trim, which covers the shading device at least in some segments and comprises a door interior waist rail and is fastened to the door body structure. The door interior trim has a support module, on which the functional components of the shading device are arranged and which is fastened to the door body structure.

The invention relates to a motor vehicle door having a window arrangement which is integrated into a door body structure, and having a shading device, assigned to the window arrangement on the inner side of the door, with a plurality of functional components, and having a door interior trim at least partially covering the shading device, said door interior trim comprising a door interior breastwork and being fastened to the door body structure.

A motor vehicle door of this type is well known for passenger cars. The motor vehicle door has a window arrangement held in a window frame of a door body structure. On the inner side of the vehicle, the window arrangement is assigned a shading device which comprises a flexible shading structure that is windable and unwindable on a winding shaft. The shading structure at least largely covers the window arrangement in a shading position. In a rest position, the shading structure is wound onto the winding shaft, which is mounted in a rotatable manner beneath a door breastwork on the door body structure. The shading structure has, in its front end region in the extension direction, a dimensionally stable extension profile which is guided in a vertically displaceable manner in lateral guide rails. The lateral guide rails extend along the window arrangement and are fastened to the window frame and accordingly to the door body structure. Toward the vehicle interior, an inner side of the door body structure is concealed by a door interior trim which has substantially esthetic functions.

The object of the invention is to create a motor vehicle door of the type mentioned at the beginning, which allows easy, reliable and low-tolerance mounting of the shading device.

This object is achieved in that the door interior trim has a carrier module on which the functional components of the shading device are arranged and which is fastened to the door body structure. The carrier module serves for mounting all of the functional components of the shading device such that the shading device is able to be mounted on the carrier module to form a preassembled structural unit. All that is then necessary is for the preassembled carrier module to be connected to the door body structure without complicated adjusting and mounting work having to be carried out on the motor vehicle door itself. The structural unit preassembled with the mounted functional components by the carrier module can be delivered in a fully assembled manner onto an assembly line of a corresponding manufacturer of the motor vehicle door, without further functional components of the shading device having to be mounted in a complicated manner on the door body structure. Production and mounting tolerances during the attachment of the shading device to the motor vehicle door, as need to be taken into consideration in the prior art, can be reduced or avoided according to the invention. If the shading device is operated by means of a drive system, the functional components which are arranged on the carrier module also comprise corresponding components of the drive system. After the corresponding carrier module has been mounted on the motor vehicle door, all that is then necessary is for it to be electrically connected to an on-board power supply system of the motor vehicle in order to ensure the functionality of the shading device. As a result of the solution according to the invention, tensions, frictional losses of the drive system or of the guide of the shading structure, and also folds in the shading structure, which can arise in the prior art as a result of complicated mounting and adaptation to corresponding portions of the door body structure, can be avoided. The shading device can be operable manually or by means of the drive system.

In a further configuration of the invention, the carrier module has the door interior breastwork. The door interior breastwork forms a downward boundary of the window arrangement of the motor vehicle door.

In a further configuration of the invention, the carrier module has frame portions for the window arrangement, guide rails of the shading device being assigned to said frame portions. Accordingly, the carrier module also extends upward over the door interior breastwork into the region of the window arrangement, wherein the carrier module forms frame portions of the window frame on the inner side of the door, guide rails, which serve to guide an extension profile of a, shading structure of the shading device, being integrated into said frame portions. In the frame regions, it is also possible for drive transmission means, such as in particular thread pitch cables of a drive system for the shading device, to be guided.

In a further configuration of the invention, the carrier module has, in the region of the door interior breastwork, a passage for a flexible shading structure and also a movably mounted closing part in order to close or free up the passage. The movable closing part is preferably a pivotable flap which, depending on whether the extension profile of the shading structure and the shading structure itself has passed through, can be opened and closed. Advantageously, the movably mounted closing part is controllable depending on actuation of a drive system of the shading device.

In a further configuration of the invention, the carrier module has mounting or fastening points for a winding shaft of the shading structure and also for a drive system of the shading device. The mounting or fastening points can be formed integrally on the carrier module or be mounted on the carrier module as separate components.

In a further configuration of the invention, the carrier module is provided, on an inner side facing a vehicle interior, with an interior trim arrangement coordinated with the vehicle interior trim. The interior trim arrangement is coordinated in terms of its esthetic design to the vehicle interior trim, in order to allow consistent esthetic integration in terms of design of the inner side of the motor vehicle door into the overall impression of the vehicle interior design.

In a further configuration of the invention, the carrier module has at least one holder in order to be fastened in particular releasably to the door body structure. The at least one holder can be integrated in one piece into the carrier module. The holder can be realized in particular by latching elements which cooperate with complementary latching elements in the region of the door body structure. This allows easy mounting of the preassembled structural unit made up of the carrier module and all the functional components of the shading device in the region of the inner side of the motor vehicle door.

In a further configuration of the invention, the carrier module is designed as an integral plastics component. In the plastics component, the at least one holder and corresponding mounting or fastening points for functional components of the shading device can be integrated.

Further advantages and features of the invention can be gathered from the claims and from the following description of a preferred exemplary embodiment of the invention which is illustrated by the drawings.

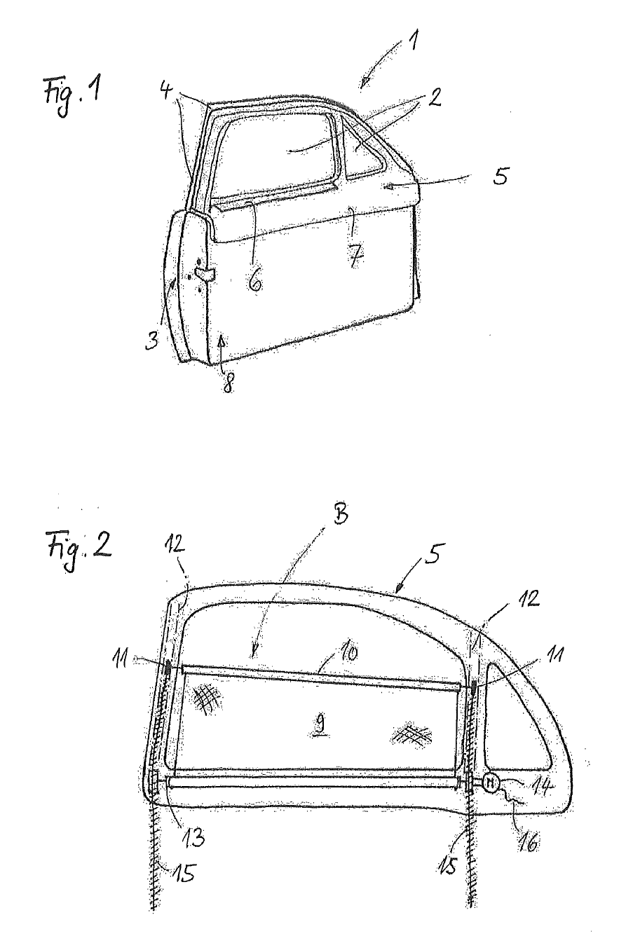

FIG. 1 shows a schematic perspective illustration of an embodiment of a motor vehicle door, according to the invention, for a passenger car, and

FIG. 2 shows a schematic view of a carrier module for the motor vehicle door according to FIG. 1.

A motor vehicle door 1 according to FIG. 1 is provided for a passenger car. The motor vehicle door 1 is a rear side door of the passenger car in the exemplary embodiment illustrated. The motor vehicle door 1 has, above a door interior breastwork 7, a window arrangement 2 which is accommodated in a window frame 4 of a door body structure 3. At least one window of the window arrangement 2 can be embodied so as to be lowerable in the door body structure 3. On the inner side of the door, the window arrangement 2 is assigned a shading device B which can be seen in FIG. 2. The shading device B is integrated in a dimensionally stable carrier module 5 which is fastened from a door inner side to the door body structure 3 in the region of the window frame 4 and at the height of the door interior breastwork 7. In the region of the window arrangement 2, the carrier module 5 has two cutouts which are coordinated with the dimensions of the window arrangement. The cutouts are surrounded by frame portions which are coordinated with corresponding frame portions of the window frame 4. The frame portions are integral constituents of the carrier module 5, which is embodied as an integral, dimensionally stable plastics component in the exemplary embodiment illustrated.

In the region of an underside of the cutout for the larger window of the window arrangement 2, the carrier module 5 has a movable closing part 6 which is designed as a flap mounted in a pivotable manner on the carrier module 5. The closing part 6 is provided in the region of a top side of the door interior breastwork 7 and extends substantially along the entire length of the larger window of the window arrangement 2—as seen in the longitudinal direction of the vehicle. In the closed position, the closing part 6 closes a passage through which a shading structure 9 of the shading device B can be extended upward. The shading structure 9 is held in a windable and unwindable manner on a winding shaft 13 which is mounted in a rotatable manner at two mounting points (not illustrated) of the carrier module 5. The winding shaft 13 is mounted on the carrier module 5 on the inner side, i.e. on a side facing the door body structure 4. Likewise on this inner side, a drive motor 14 of a drive system is fastened to the carrier module 5, said drive motor 14 driving two drive transmission means 15 in the form of thread pitch cables synchronously with one another via a transmission which is not designated further. To this end, the two thread pitch cables 15 are assigned worm gears which are arranged on a common axis, specifically on opposite end sides of the winding shaft 13. The worm gears are oriented coaxially with the axis of rotation of the winding shaft 13. In the exemplary embodiment illustrated, the winding shaft 13 is embodied as a synchronization shaft for the two worm gears, such that driving via the drive motor 14 inevitably brings about rotation of the two worm gears and accordingly a longitudinal displacement of the two thread pitch cables 15. The drive motor 14 is embodied as an electric motor. The thread pitch cables 15 are laid in guide rails 12 in frame portions of the carrier module 5, wherein the guide rails 12 extend substantially in the vertical direction of the vehicle on opposite sides of the cutout for the larger window of the window arrangement 2. The guide rails 12 are either formed integrally in the manner of slot-like profiles in the carrier module 5, or the guide rails 12 are fastened as separate guide profiles to the inner side of the carrier module in the region of the frame portions. A guide member 11 is guided in a linearly movable manner in each of the guide rails 12. The guide members 11 are assigned to opposite end sides of a dimensionally stable extension profile 10 which is fastened to a front end region, in the extension direction, of the web-like shading structure 9. The extension profile 10 is displaceable in a parallel manner between a rest position, lowered in the passage that is closeable by the closing part 6, and a functional position which has been traveled to upward as far as an upper frame portion of the carrier module 5, in that the guide members 11 are moved along by means of the thread pitch cables 15 in the guide rails 12. All of the functional components of the shading device B, i.e. the winding shaft 13 with the shading structure 9 and the extension profile 10, the guide rails 12, the guide members 11, the thread pitch cables 15 and further components of the drive system such as the drive motor 14 and the associated transmission with the worm gears, are arranged on and fastened to the inner side of the carrier module 5 via corresponding fastening or mounting points. Inner side should be understood as meaning, with regard to the carrier module 5, the side that faces away from the vehicle interior toward the door body structure 3 with the window frame 4. On the opposite side, facing the vehicle interior, the carrier module 5 is provided with a surface coordinated with the vehicle interior trim, said surface being able to be provided with an interior trim arrangement in the form of a coating and/or covering, wherein the interior trim arrangement is coordinated esthetically and in terms of design with the rest of the vehicle interior trim.

The carrier module 5, including all of the functional components of the shading device B, is able to be preassembled in a functional manner before the carrier module 5 provided with the shading device B is attached to the inner side of the door body structure 3, 4. To this end, the carrier module 5 has a plurality of holders, which are not discernible in FIGS. 1 and 2. The holders can be formed by mechanical latching arrangements and/or by additional fastening arrangements that are operable by means of a tool, said arrangements each being provided in a complementary manner in the region of the door body structure 3 including the window frame 4 and in the region of the carrier module 5. If the holders are formed by latching arrangements, it is advantageously possible to connect the fully preassembled carrier module 5 to the door body structure 3 without tools in that the carrier module 5 is latched together with the door body structure.

In the exemplary embodiment illustrated in FIGS. 1 and 2, the carrier module 5 extends only over an upper region of the door body structure 3, i.e. substantially over the height and width of the window frame 4 and the window arrangement 2 down to the height of the door interior breastwork 7. In an exemplary embodiment (not illustrated) of the invention, the carrier module extends over the entire height and width of a door body structure, i.e. as far as a lower end region of the door body structure. In this way, the carrier module forms a complete inner side of the motor vehicle door.

As soon as the carrier module 5 has been mounted on the door body structure 3, all that is then necessary is to connect power supply and control lines 16 for the drive system of the shading device B to an on-board power supply system of the vehicle and a controller of the vehicle in order to prepare the shading device B in an operational manner.

1. A motor vehicle door having a window arrangement which is integrated into a door body structure, and having a shading device, assigned to the window arrangement on the inner side of the door, with a plurality of functional components, and having a door interior trim at least partially covering the shading device, said door interior trim comprising a door interior breastwork and being fastened to the door body structure, wherein the door interior trim has a carrier module on which the functional components of the shading device are arranged and which is fastened to the door body structure.

2. The motor vehicle door as claimed in claim 1, wherein the carrier module has the door interior breastwork.

3. The motor vehicle door as claimed in claim 1, wherein the carrier module has frame portions for the window arrangement, guide rails of the shading device being assigned to said frame portions.

4. The motor vehicle door as claimed in claim 2, wherein the carrier module has, in the region of the door interior breastwork, a passage for a flexible shading structure and also a movably mounted closing part in order to close or free up the passage.

5. The motor vehicle door as claimed in claim 1, wherein the carrier module has mounting or fastening points for a winding shaft of the shading structure and also for a drive system of the shading device.

6. The motor vehicle door as claimed in claim 1, wherein the carrier module is provided, on an inner side facing a vehicle interior, with an interior trim arrangement coordinated with the vehicle interior trim.

7. The motor vehicle door as claimed in claim 1, wherein the carrier module has at least one holder in order to be fastened in particular releasably to the door body structure.

8. The motor vehicle door as claimed in claim 1, wherein that the carrier module is designed as an integral, dimensionally stable plastics component.
